(19) United States
(12) Patent Application Publication
(10) Pub. No.: US 2015/0220688 A1
(43) Pub. Date: Aug. 6, 2015

(54) INFORMATION PROCESSING SYSTEM AND NON-TRANSITORY COMPUTER READABLE RECORDING MEDIUM

(71) Applicant: Konica Minolta, Inc., Tokyo (JP)

(72) Inventor: Kosuke SASAI, Kobe-shi (JP)

(21) Appl. No.: 14/608,858

(22) Filed: Jan. 29, 2015

(30) Foreign Application Priority Data
Jan. 31, 2014 (JP) 2014-016501

(51) Int. Cl. G06F 19/00

(52) U.S. Cl. CPC G06F 19/326

(57) ABSTRACT

An information processing system includes a storage, a designation unit, an extraction unit, and an output controller. The storage stores a plurality of element combinations in each of which elements belonging to two or more of a plurality of items concerning a current state of a patient are associated, and explanation information pieces each to be presented to a patient associated with a corresponding one of the element combinations and/or a person relevant to the patient. The designation unit designates, in response to a signal according to a user action, a combination of elements belonging to two or more of the plurality of items. The extraction unit extracts, from the explanation information pieces stored in the storage, an explanation information piece corresponding to the combination designated by the designation unit. The output controller causes an output unit to output the explanation information piece extracted by the extraction unit.

The present U.S. patent application claims a priority under the Paris Convention of Japanese patent application No. 2014-016501 filed on Jan. 31, 2014, the entirety of which is incorporated by references.

### BACKGROUND OF THE INVENTION

1. Field of the Invention

The present invention relates to an information processing system and a non-transitory computer readable recording medium.

2. Description of the Background Art

In medical institutions, such as a hospital, patients consult their doctors, and receive various explanations from them. In such cases, doctors tend to provide only almost perfunctory explanations to patients for lack of time to provide sufficient explanations. Even if patients receive fairly detailed explanations from their doctors, the best they can do is often to temporarily understand part of the explanations. Especially for elderly patients, it is often difficult to understand doctors' explanations. Furthermore, in order for patients to share doctors' explanations with their family members, the patients are required to be accompanied by the family members when consulting doctors. Even when patients are accompanied by their family members, however, it is often difficult for doctors to take sufficient time to provide explanations. As a result, patients and their family members find it difficult to correctly understand information on a disease name, a cause of a disease, a means of coping with a disease, matters they should be careful about in daily life, and the like.

To address the aforementioned problem, a medical support system for providing a commentary to a doctor's explanation for a patient and a method for providing the commentary have been proposed (e.g., Japanese Patent Application Laid-Open No. 2010-072786). In this technology, a dictionary for commentaries in which terms and sentences describing the respective terms are associated with each other is stored in advance. When explanation information for a patient in an audio data format is obtained, the explanation information is converted into a character data format through analysis. Terms included in the explanation information in the character data format are then each compared with the dictionary for commentaries. Explanation information with a commentary is generated from the explanation information and sentences that are associated with the respective terms included in the explanation information, and output.

In the technology disclosed in Japanese Patent Application Laid-Open No. 2010-072786 above, however, contents of the sentences associated with the respective terms only fall within a range of an explanation provided orally by a doctor. In the current situation in which it is difficult for doctors to spend time to provide patients with a thorough explanation on a cause of a disease, a medical condition, a causal relationship, a means of coping with a disease, and the like, a subject including a patient cannot obtain adequate information.

### SUMMARY OF THE INVENTION

An object of the present invention is therefore to provide technology that enables presentation of an appropriate explanation according to a current state of each patient to a subject.

To achieve the above-mentioned object, an information processing system reflecting one aspect of the present invention includes a storage, a designation unit, an extraction unit, and an output controller. The storage stores a plurality of element combinations in each of which elements that belong to two or more of a plurality of items concerning a current state of a patient are associated with one another, and explanation information pieces each to be presented to one or more of a patient who is associated with a corresponding one of the element combinations and a person who is relevant to the patient. The designation unit designates, in response to a signal according to a user action, a combination of elements belonging to two or more of the plurality of items. The extraction unit extracts, from the explanation information pieces stored in the storage, an explanation information piece that corresponds to the combination of elements designated by the designation unit. The output controller causes an output unit to output the explanation information piece extracted by the extraction unit.

Another aspect of the present invention is also directed to a non-transitory computer readable recording medium storing a computer-readable program, the program controlling an information processing system to operate as one information processing system. The one information processing system includes a storage, a designation unit, an extraction unit, and an output controller. The storage stores therein a plurality of element combinations in each of which elements that belong to two or more of a plurality of items concerning a current state of a patient are associated with one another, and explanation information pieces each to be presented to one or more of a patient who is associated with a corresponding one of the element combinations and to a person who is relevant to the patient. The designation unit designates, in response to a signal according to a user action, a combination of elements belonging to two or more of the plurality of items. The extraction unit extracts, from the explanation information pieces stored in the storage, an explanation information piece that corresponds to the combination of elements designated by the designation unit. The output controller causes an output unit to output the explanation information piece extracted by the extraction unit.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates an overall configuration of an information processing system according to one embodiment;

FIG. 2 is a block diagram showing main components of an in-hospital system according to the one embodiment;

FIG. 3 is a block diagram showing examples of support information and examples of functional components for processing to build up support information;

FIG. 4 shows examples of a finding sentence;

FIG. 5 is a diagram for describing the structure of the finding sentences;

FIG. 6 shows an example of a combination number table;

FIG. 7 shows an example of explanation association information;

FIG. 8 shows an example of an explanation information piece;

FIG. 9 is a block diagram showing examples of functional components for implementing report creation processing;

FIG. 10 shows an example of an examination list screen;

FIG. 11 shows an example of a diagnosis support screen;

FIGS. 12A to 12E are enlarged views showing an example of a third area of the diagnosis support screen;

FIG. 13 is an enlarged view showing an example of a fourth area of the diagnosis support screen;

FIG. 14 shows an example of a detail input window;

FIG. 15 is a block diagram showing examples of functional components for implementing explanation presentation processing; and

FIG. 16 shows an example of an explanation presentation window.

### DETAILED DESCRIPTION OF THE INVENTION

The following describes one embodiment and modifications of the present invention based on the drawings. It should be noted that components having a similar structure and function bear the same reference sign in the drawings, and repetition of description thereof is avoided below. The drawings are those shown schematically, and sizes of and positional relationships among various components in each of the drawings are not accurate, and may be changed as appropriate.

### <(1) Overall Configuration of Information Processing System>

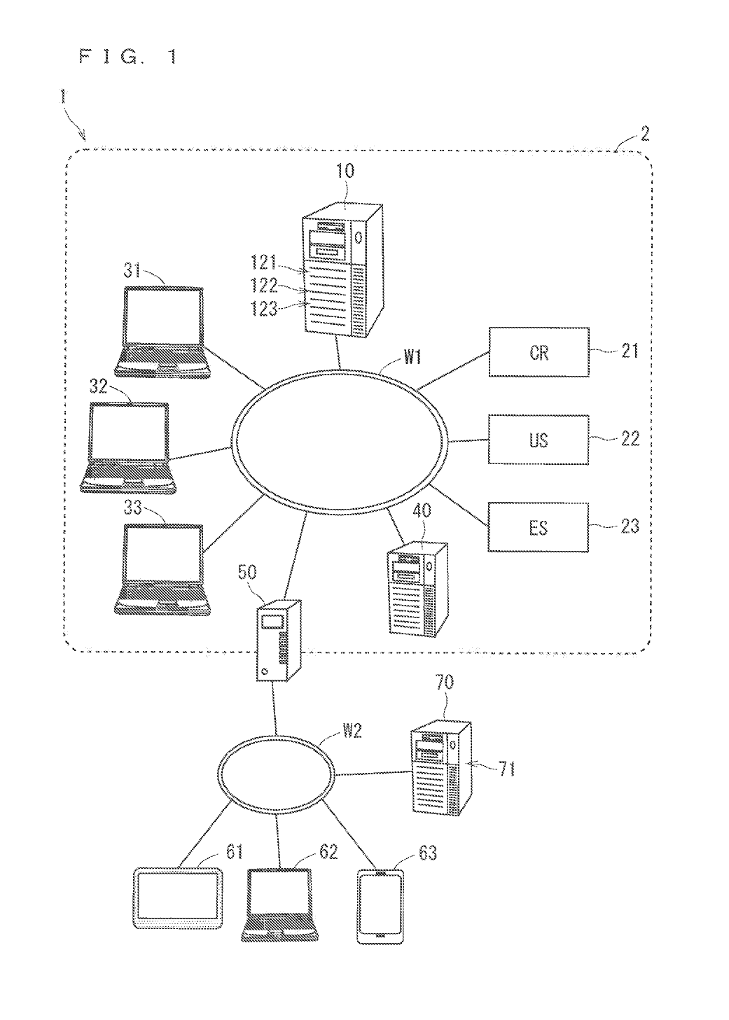

FIG. 1 illustrates an overall configuration of an information processing system 1 according to the one embodiment.

The information processing system 1 includes an information processing system in a hospital (also referred to as an in-hospital system) 2, terminal devices 61-63, and a data center server (also referred to as a DC server) 70, for example.

The in-hospital system 2 includes a main server 10, examination devices, such as a computed radiography (CR) device 21, an ultrasound diagnostic (US) device 22, and an endoscope (ES) device 23, terminal devices 31-33, a mail server 40, and a firewall device 50, for example. The devices included in the in-hospital system 2 are connected to one another via a communication line W1 for data transmission/reception. The communication line W1 may be wired or wireless. In the present embodiment, the communication line W1 is a local area network (LAN).

The main server 10 is a main server in the in-hospital system 2, and includes a medical care information database (medical care information DB) 121, a support information database (support information DB) 122, and a data group 123.

The medical care information DB 121 is a database that stores therein medical information (also referred to as medical care information) of many patients who are subjects of medical examination and medical care. The medical care information DB 121 includes information on electronic medical records of many patients (also referred to as an electronic medical record group) and a list of many examinations (also referred to as an examination list). The medical care information DB 121 also stores therein image data for each of the examinations listed in the examination list and data (also referred to as report data) on a report (also referred to as a diagnostic result report) of a diagnostic result corresponding to the image data, in association with identification information, such as an examination ID, listed in the examination list. The image data includes image data obtained by one or more of the examination devices that include the CR device 21, the US device 22, and the ES device 23, for example. The diagnostic result report includes a radiologic interpretation report, for example. The medical care information DB 121 further stores therein attribute information in association with the identification information listed in the examination list. The attribute information includes information on an attribute of a patient (also referred to as a patient attribute) and an attribute of an examination (also referred to as an examination attribute). The patient attribute includes age, sex, and stratification, such as an age group, for example. The examination attribute includes a type of and a condition for an examination, for example.

The support information DB 122 is a database that stores therein information (also referred to as support information) to support a medical practice, including diagnosis, undertaken by a doctor as a first user. The doctor includes a radiologist who interprets radiographs and a doctor in charge in each department, for example. In the present embodiment, the support information includes information to perform processing to support a medical practice (also referred to as medical care support processing), such as report creation processing and explanation presentation processing, for example. The report creation processing is information processing performed by a doctor to create a diagnostic result report. The explanation presentation processing is information processing to present information (also referred to as presentation information) to one or more of a patient and a person who is relevant to the patient in accordance with a diagnostic result. The person who is relevant to the patient includes a family member of the patient, for example.

The data group 123 includes a variety of data that is required to perform the report creation processing and the explanation presentation processing, for example.

The terminal devices 31-33 are each in the form of a personal computer (hereinafter, abbreviated as a PC), for example. In the present embodiment, the terminal devices 31-33 are PCs distributed to doctors, who are the first users. When doctors create diagnostic result reports by using the terminal devices 31-33, for example, the medical care support processing, such as the report creation processing and the explanation presentation processing, is performed based on the support information stored in the support information DB 122. Furthermore, when doctors in charge examine patients, processing to generate, by using the terminal devices 31-33, presentation information based on the diagnostic result reports created by the doctors may be supported.

The mail server 40 performs transmission/reception of emails. The firewall device 50 connects the in-hospital system 2 to a communication line W2 outside a hospital. The communication line W2 may be wired or wireless. In the present embodiment, the communication line W2 is the Internet.

The terminal devices 61-63 are each in the form of a tablet terminal, a PC, or a smartphone, for example. In the present embodiment, the terminal devices 61-63 are used by a patient and a person who is relevant to the patient as second users. The terminal devices 61-63 and the firewall device 50 are connected to one another via the communication line W2 for data transmission/reception. With this structure, a variety of information can be transmitted, for example, in the form of emails from the terminal devices 31-33 to the terminal devices 61-63 via the mail server 40, the firewall device 50, and the communication line W2. As a result, a patient and a person who is relevant to the patient can easily obtain the presentation information.

The DC server 70 is a server that provides a variety of information to support health, for example. The DC server 70 is installed by an organization that provides a health support service, for example. In the present embodiment, the DC server 70 is connected to the terminal devices 61-63 and the firewall device 50 via the communication line W2 for data transmission/reception. It is sufficient that the DC server 70 is a server that provides an application service provider (ASP) service. The DC server 70 includes a personal health record (PHR) 71. The PHR 71 includes information showing a state, such as health, of each user of the information processing system 1. The PHR 71 is built up by obtaining at least part of information on the electronic medical record group included in the medical care information DB 121 from the electronic medical record group included in the main server 10. In response to a request from a patient and a person who is relevant to the patient, who are the second users, via the terminal devices 61-63, the DC server 70 transmits health information of each user to the terminal devices 61-63 via the communication line W2 as appropriate, and the terminal devices 61-63 output the transmitted information in various forms.

<(2) Main Functional Components of in-Hospital System>

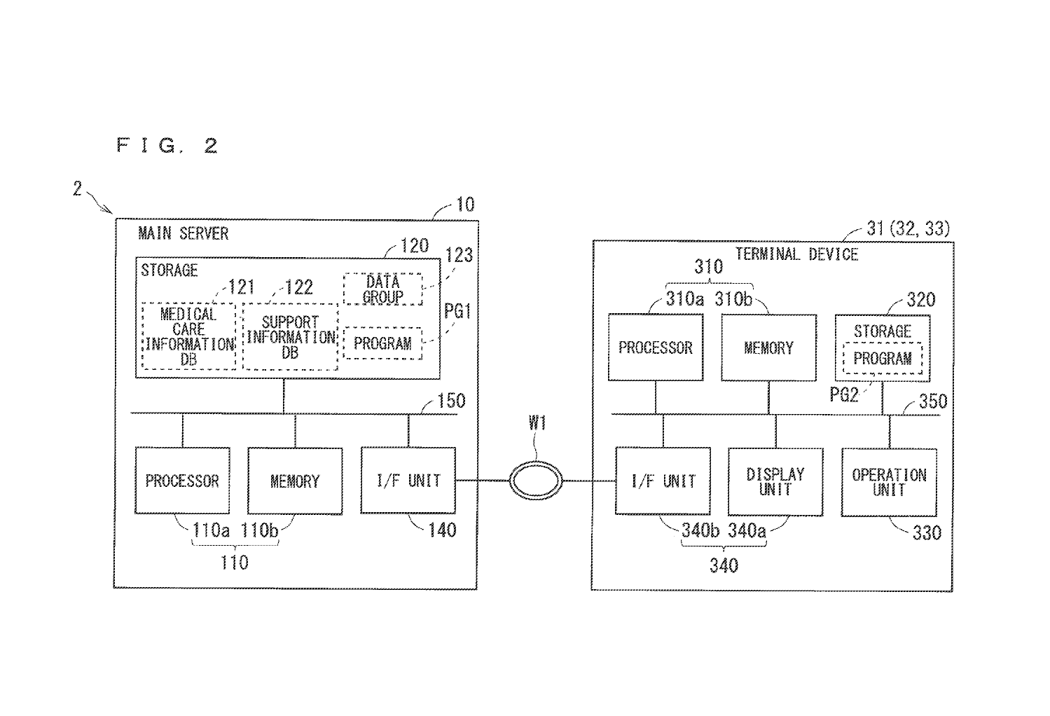

FIG. 2 is a block diagram showing examples of main functional components of the in-hospital system 2.

As shown in FIG. 2, the main server 10 has a functional configuration in which a controller 110, a storage 120, and an interface (I/F) unit 140 are connected to a bus line 150. This functional configuration is similar to that of a typical computer. The bus line 150 is connected to the communication line W1 via the I/F unit 140.

The controller 110 includes a processor 110a, such as a central processing unit (CPU), and volatile memory 110b, such as random access memory (RAM), for example. The processor 110a achieves the medical care support processing including the report creation processing and the explanation presentation processing by reading a program PG1 stored in the storage 120 and performing a variety of processing in accordance with the program PG1. That is to say, functions of the information processing system 1 that performs the medical care support processing are achieved by the processor 110a executing the program PG1.

The storage 120 includes non-volatile semiconductor memory or a hard disk, for example. The storage 120 stores therein the medical care information DB 121, the support information DB 122, the data group 123, and the program PG1. The data group 123 can include data that indicates a parameter and the like that are required to perform processing in accordance with the program PG1 and data that is at least temporarily generated as a result of arithmetic processing, for example.

The terminal devices 31-33 have a similar functional configuration. Description is thus made only on the terminal device 31 as a representative example of the terminal devices 31-33.

As shown in FIG. 2, the terminal device 31 has a functional configuration in which a controller 310, a storage 320, an operation unit 330, and an output unit 340 are connected to a bus line 350. This functional configuration is similar to that of a typical computer. The bus line 350 is connected to the communication line W1 via an I/F unit 340b included in the output unit 340.

The controller 310 includes a processor 310a, such as a CPU, and volatile memory 310b, such as RAM, for example. The processor 310a achieves the medical care support processing including the report creation processing and the explanation presentation processing by reading a program PG2 stored in the storage 320 and performing a variety of processing in accordance with the program PG2. That is to say, functions of the information processing system 1 that performs the medical care support processing are achieved by the processor 310a executing the program PG2.

The storage 320 includes non-volatile semiconductor memory or a hard disk, for example, and stores therein the program PG2 and a variety of data. The variety of data can include data that indicates a parameter and the like that are required to perform processing in accordance with the program PG2 and data that is at least temporarily generated as a result of arithmetic processing.

The operation unit 330 includes a pointing device, such as a keyboard and a mouse, for example. The operation unit 330 outputs, to the controller 310, a signal (also referred to as an instruction signal) that is generated in accordance with an operation performed on the keyboard, the mouse, and the like. The operation unit 330 may be in the form of a touch panel, or the like.

The output unit 340 includes a display unit 340a and an I/F unit 340b, for example. The display unit 340a visually outputs various images. The I/F unit 340b outputs, to a device outside the terminal device 31, a variety of information, including the presentation information, in the form of a signal. The display unit 340a includes various display devices, such as a liquid crystal display (LCD), for example. The display unit 340a visually outputs a variety of information in response to a signal input from the controller 310. The I/F unit 340b performs data transmission/reception with a device outside the terminal device 31 via the communication line W1.

### <(3) Medical Care Support Processing>

Description is made below by taking a case where a doctor, who is the first user, uses the terminal device 31 as an example.

### <(3-1) Support Information and Building of Support Information>

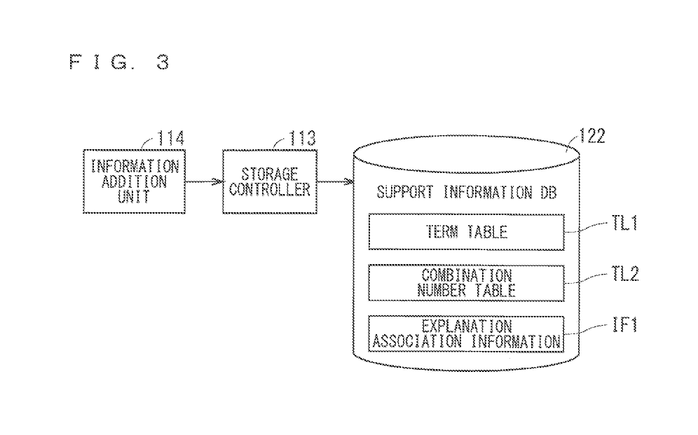

FIG. 3 is a block diagram showing examples of support information stored in the support information DB 122 included in the information processing system 1 and examples of functional components for processing to build up the support information.

The information processing system 1 includes a storage controller 113 and an information addition unit 114 as functional components for implementing support information building processing achieved by the controller 110, for example. The support information DB 122 includes a term table TL1, a combination number table TL2, and explanation association information IF1, for example.

The term table TL1 is a table in which, with respect to a finding sentence included in a diagnostic result report and the attribute information concerning the finding sentence, one or more terms, as elements, that can be used as a term that belongs to a corresponding one of items are listed for each item. When a finding sentence included in a radiologic interpretation report is taken as an example, the item includes items concerning the attribute information, such as “examined body part” and “shooting condition”, and a plurality of items concerning a current state of a patient, such as “basic body part”, “basic findings”, and “diagnosis”. That is to say, in the present embodiment, the plurality of items include a plurality of items concerning a body part, findings, and diagnosis. A term includes a symbol that represents the term.

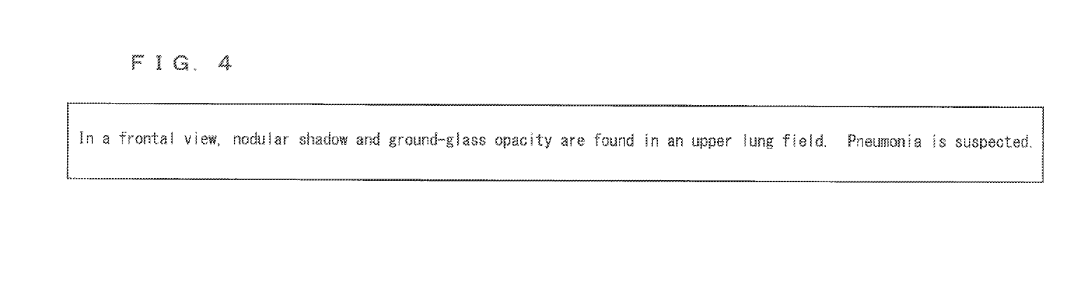

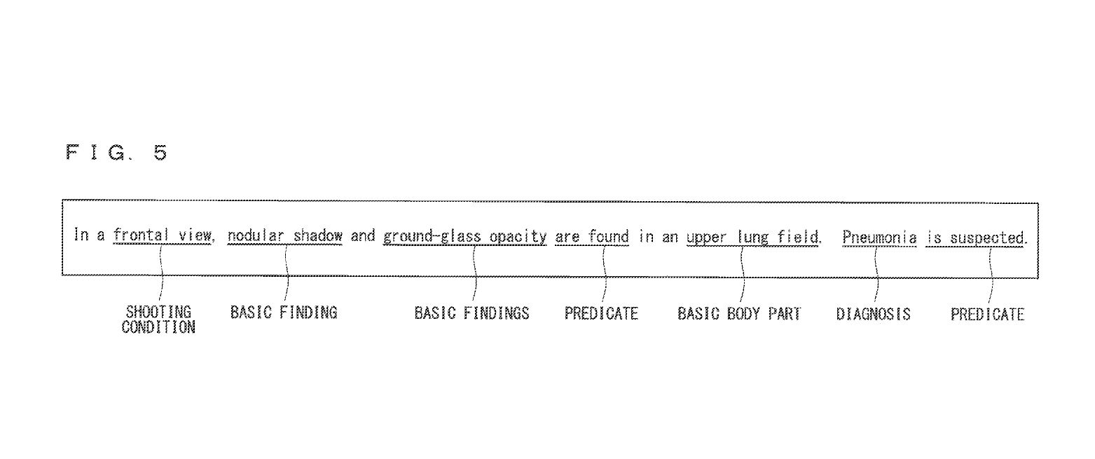

FIG. 4 shows examples of a finding sentence. FIG. 5 is a diagram for describing the structure of the finding sentences shown in FIG. 4. As shown in FIG. 5, the finding sentences shown in FIG. 4 are composed of terms that belong to four main items (shooting condition, basic body part, basic findings, diagnosis) and the other words and phrases (e.g., a preposition and a predicate). Specifically, the finding sentences shown in FIG. 4 are composed of a term “frontal view” that belongs to the item “shooting condition”, a term “upper lung field” that belongs to the item “basic body part”, terms “nodular shadow” and “ground-glass opacity” that belong to the item “basic findings”, a term “pneumonia” that belongs to the item “diagnosis”, and the other words and phrases. Therefore, in the term table TL1, one or more terms such as “frontal view” are listed as terms that belong to the item “shooting condition”, and one or more terms such as “upper lung field” are listed as terms that belong to the item “basic body part”. Furthermore, in the term table TL1, one or more terms such as “nodular shadow” and “ground-glass opacity” are listed as terms that belong to the item “basic findings”, and one or more terms such as “pneumonia” are listed as terms that belong to the item “diagnosis”.

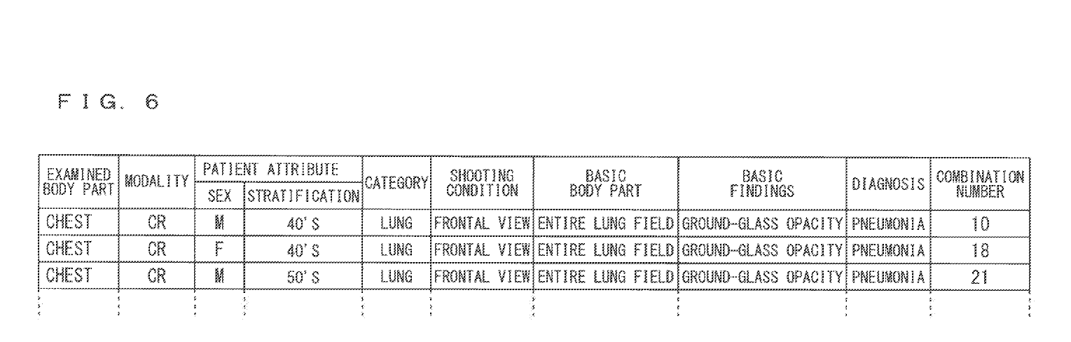

The combination number table TL2 is a table regarding information that indicates frequency of combination of terms used in a diagnostic result report including a finding sentence. As the frequency, the number of times terms used in many past diagnostic result reports are combined can be used, for example. FIG. 6 shows an example of part of the combination number table TL2. As shown in FIG. 6, the number of times terms used in many past diagnostic result reports are combined are listed for each combination of terms, counting a combination of terms used in a single past diagnostic result report as one combination of terms.

The term table TL1 and the combination number table TL2 are stored in the storage 120 by the storage controller 113 as data constituting the support information DB 122. The term table TL1 and the combination number table TL2 are herein stored such that combinations of terms can be distinguished from one another by a combination of a term concerning an examined body part (e.g., CHEST and HEAD) and a term concerning a modality (e.g., CR, ES, and US), and can further be distinguished from one another by a term concerning a category.

The term table TL1 and the combination number table TL2 as described above can be created from information obtained by structuring many diagnostic result reports with use of a resource description framework (RDF) and an extensible markup language (XML), for example. For example, structuring with use of the resource description framework (RDF) or the like is achieved by extracting, as for each diagnostic result report, a necessary element from a finding sentence as a natural sentence as well as various elements included in the attribute information. As a result, as for many diagnostic result reports, data on many structured reports (also referred to as structured report data) are generated respectively. In the present embodiment, an element extracted from a finding sentence and the attribute information is a term. A term includes a symbol that represents the term.

Specifically, information on a diagnostic result report is structured by dividing a variety of information included in report data and the attribute information into terms that belong to respective items and describing the terms with use of the RDF based on model data obtained through machine learning, for example. The model data is herein data of a model that indicates how elements constituting an existing radiologic interpretation report are divided into elements that belong to respective items. The items include an item concerning the attribute information (e.g., an examined body part and shooting information) and a plurality of items concerning a current state of a patient (e.g., a basic body part, basic findings, and diagnosis).

For example, the finding sentences shown in FIG. 4 are divided into terms that belong to respective items as shown in FIG. 5. Specifically, the term “frontal view” is identified as a term that belongs to the item “shooting condition”, the term “upper lung field” is identified as a term that belongs to the item “basic body part”, the terms “nodular shadow” and “ground-glass opacity” are identified as terms that belong to the item “basic findings”, and the term “pneumonia” is identified as a term that belongs to the item “diagnosis”. Many structured report data pieces thus generated may be stored in the storage 120 by the storage controller 113 as data constituting the support information DB 122.

If there are too many synonyms (e.g., terms “T2-weighted image” and “T2WI”) when the term table TL1 and the combination number table TL2 are built up, the number of terms increases excessively. With respect to synonyms, processing to replace each of the synonyms with a single representative term may be performed, for example. Replacement with the representative term can be achieved by including, in information used in machine learning, a table in which a plurality of terms are associated with a representative term, for example.

In a diagnostic result report, a term such as a modifier can be added to each of terms that belong to respective items, for example. For example, a term “right frontal lobe” is a complex of a term “frontal lobe” that belongs to the item “basic body part” and a term “right” as a modifier. In this case, a term that belongs to a detailed item “modifier” (hereinafter also referred to as a detailed element) may be identified from a finding sentence as a natural sentence, and structured report data may be generated in a form of including the detailed element. The term table TL1 and the combination number table TL2 may also be generated in the form of including the detailed element.

The number of diagnostic result reports stored in the medical care information DB 121 can increase each time a new diagnostic result report is generated in response to input from the terminal devices 31-33. Use of the diagnostic result reports stored over time as knowledge from the past is effective. Therefore, reflecting a term and a combination of terms included in a newly generated diagnostic result report in the term table TL1 and the combination number table TL2 is also effective. A newly stored diagnostic result report that includes a new finding sentence is especially valuable as the knowledge from the past is further developed.

The explanation association information IF1 is information in which combinations of a plurality of elements (a plurality of terms in the present embodiment) are associated with respective explanation information pieces. The explanation association information IF1 may be prepared in advance or may be created in the in-hospital system 2, for example. Alternatively, the explanation association information IF1 that is prepared in advance may be modified and updated in the in-hospital system 2.

The following describes processing performed when the explanation association information IF1 is generated, modified, or updated in the in-hospital system 2. The explanation association information IF1 can be generated, modified, or updated, for example, by the information addition unit 114 adding explanation information pieces to respective combinations of terms stored in the support information DB 122. The explanation information pieces are added by a doctor and other persons based on medical knowledge, for example. The combinations of terms include a plurality of combinations of terms in each of which a plurality of terms that belong to two or more of a plurality of items concerning a current state of a patient (e.g., a basic body part, basic findings, and diagnosis) are associated with one another, for example. The two or more items may not be certain items, and may be a plurality of various items, for example. The combinations of terms may include terms that belong to one or more items concerning the attribute information, such as the patient attribute. The explanation information pieces are each an information piece on an explanation sentence to be presented to one or more of a patient and a person who is relevant to the patient, for example. The explanation association information IF1 in which combinations of a plurality of terms are associated with respective explanation information pieces is thus generated. For example, by the storage controller 113 storing explanation information pieces input by the information addition unit 114 in the storage 120 in a state in which the explanation information pieces are associated with respective combinations of terms, the explanation association information IF1 as part of the support information DB 122 is stored in the storage 120.

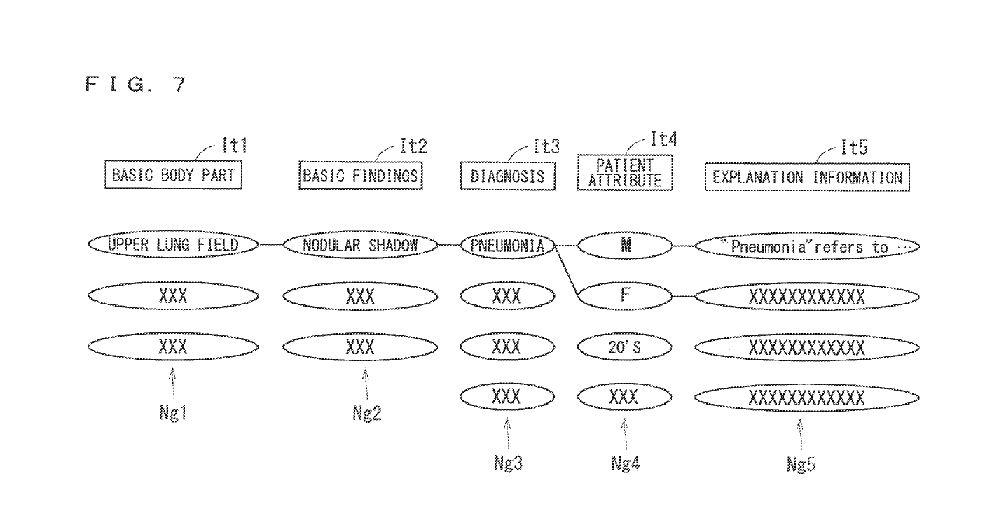

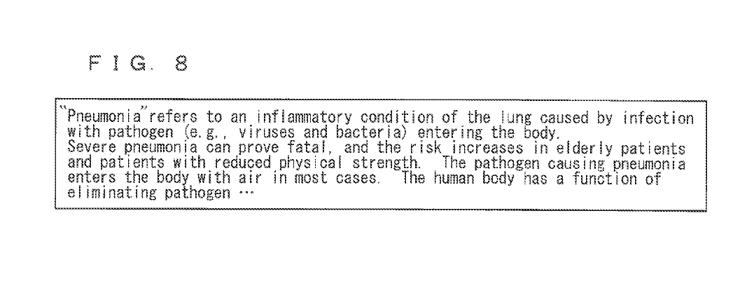

FIG. 7 shows an example of the explanation association information IF1. FIG. 8 shows an example of the explanation information piece. In the explanation association information IF1 shown in FIG. 7, terms that belong to four items (a basic body part, basic findings, diagnosis, and the patient attribute) It1-It4 are listed, and information pieces that belong to an item It5 concerning explanation information are listed. Furthermore, explanation information pieces are associated with respective combinations of terms in each of which terms that belong to the four items It1-It4 are associated with one another. Specifically, FIG. 7 shows an example in which an explanation information piece “Pneumonia refers to . . . ” (see FIG. 8) is associated with a combination of the term “upper lung field” that belongs to the item “basic body part”, the term “nodular shadow” that belongs to the item “basic findings”, the term “pneumonia” that belongs to the item “diagnosis”, and a patient attribute “male (M)”. Although a single explanation information piece is herein associated with a single combination of terms, the present invention is not limited to this structure. Two or more explanation information pieces may be associated with a single combination of terms. Furthermore, in a single combination of terms, the number of terms that belong to each item is herein only one. The present invention, however, is not limited to this structure, and two or more terms may belong to each item in a single combination of terms. The combinations of terms in the explanation association information IF1 may not include a term concerning the patient attribute. Each combination of terms is not limited to a combination of terms in which terms that belong to the four items It1-It4 are associated with one another, and may be a combination of terms in which terms that belong to any two or more items are associated with one another, for example.

### <(3-2) Report Creation Processing>

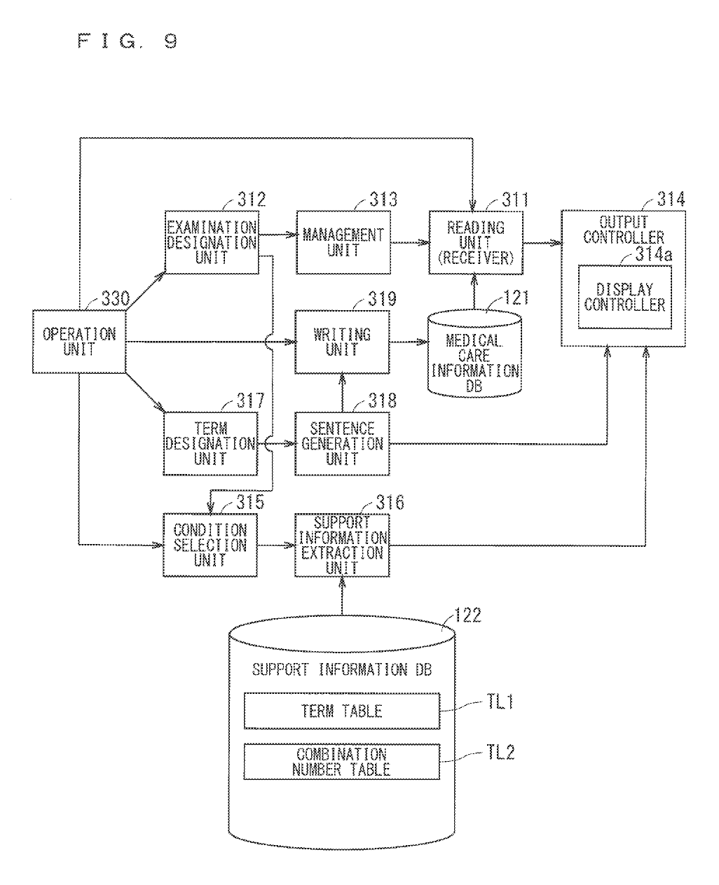

FIG. 9 is a block diagram showing examples of functional components for implementing the report creation processing in the information processing system 1.

The information processing system 1 includes, as functional components for implementing the report creation processing achieved by the controllers 110 and 310, a reading unit 311, an examination designation unit 312, a management unit 313, an output controller 314, a condition selection unit 315, a support information extraction unit 316, a term designation unit 317, a sentence generation unit 318, and a writing unit 319.

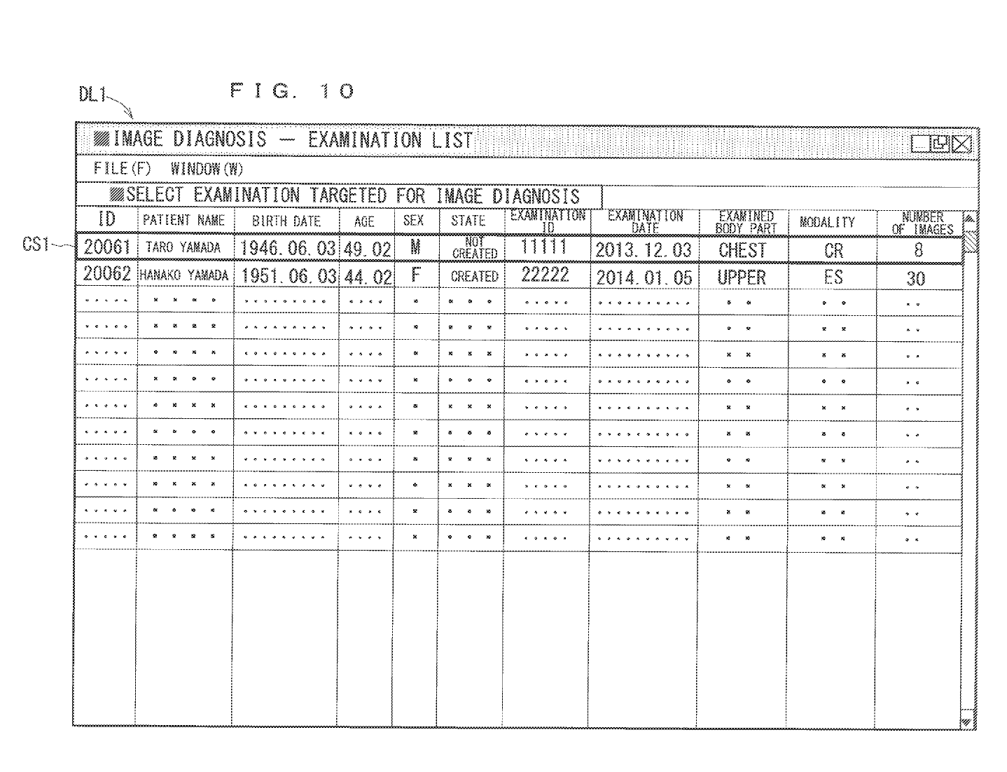

The reading unit 311 reads a variety of information from the medical care information DB 121 in response to a signal from the operation unit 330 and a command from the management unit 313. The variety of read information includes information on an examination list and a variety of data on an examination targeted for report creation (also referred to as a creation target examination). The variety of information read by the reading unit 311 is visually output from the display unit 340a through control performed by a display controller 314a included in the output controller 314. As a result, an examination list screen DL1 (FIG. 10), which is described later, is displayed by the display unit 340a, and image data on the creation target examination is visually output by the display unit 340a, for example.

The examination designation unit 312 designates a creation target examination in response to a signal from the operation unit 330.

The management unit 313 specifies a task of creating a diagnostic result report corresponding to the creation target examination designated by the examination designation unit 312, and causes the reading unit 311 to read a variety of information and data on the creation target examination from the medical care information DB 121.

The output controller 314 controls output of a variety of information. The output controller 314 includes the display controller 314a that controls visual output of a variety of information performed by the display unit 340a, for example.

The condition selection unit 315 selects a condition (also referred to as an extraction condition) for the support information extraction unit 316 extracting information from the support information DB 122. The extraction condition selected herein includes a combination of terms concerning an examined body part, a modality, and a category, for example. In the present embodiment, when a creation target examination is designated by the examination designation unit 312, information that indicates an examined body part and a modality, which are the examination attributes, included in information on the creation target examination is input into the condition selection unit 315.

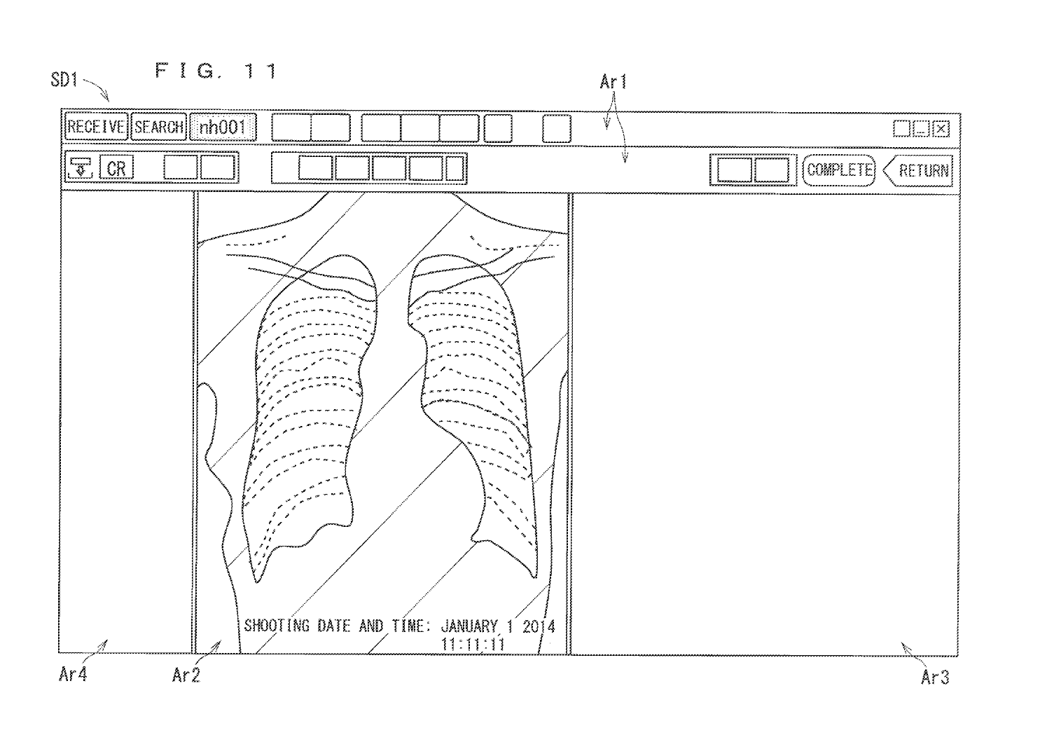

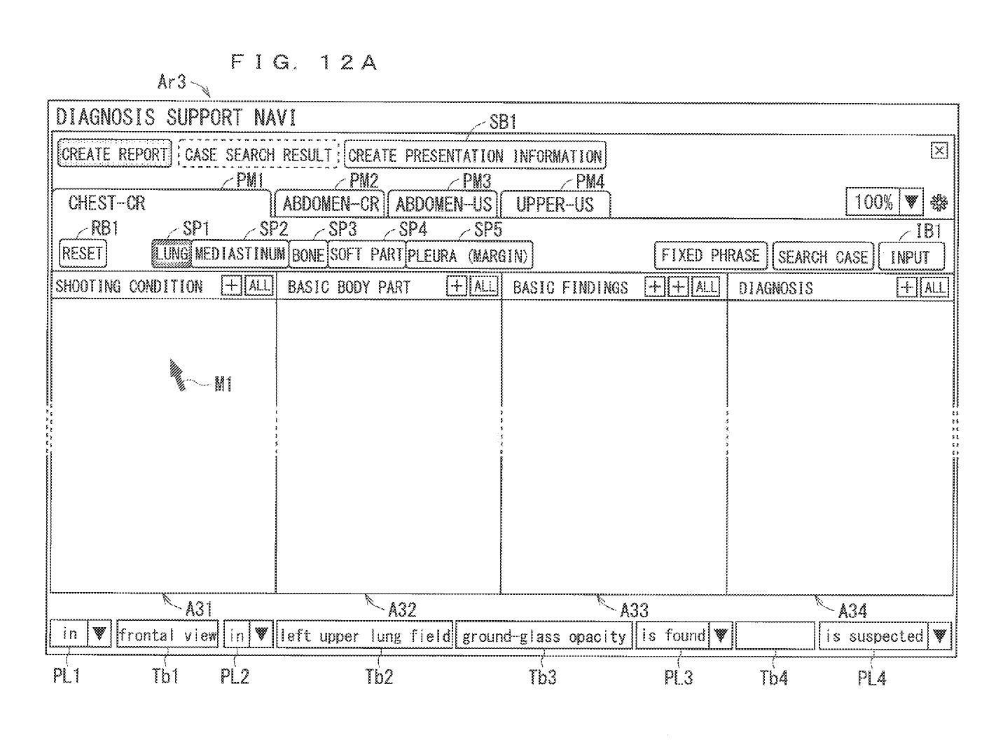

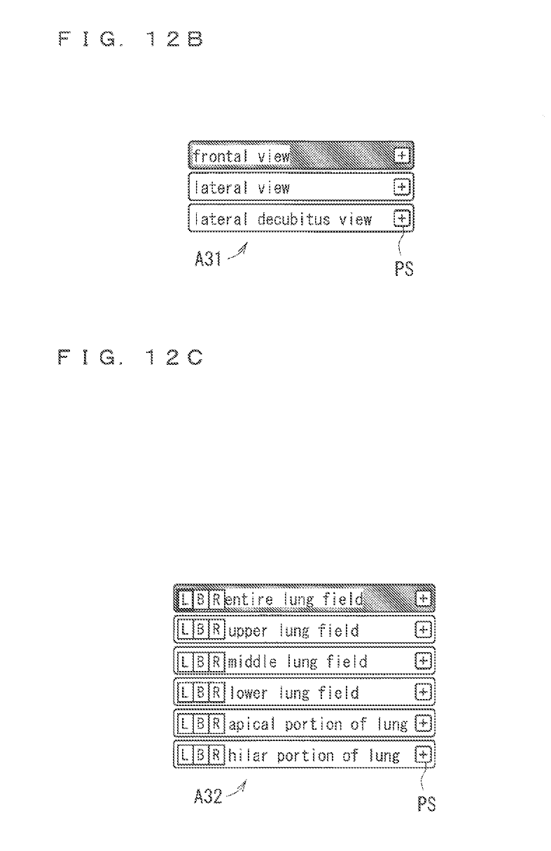

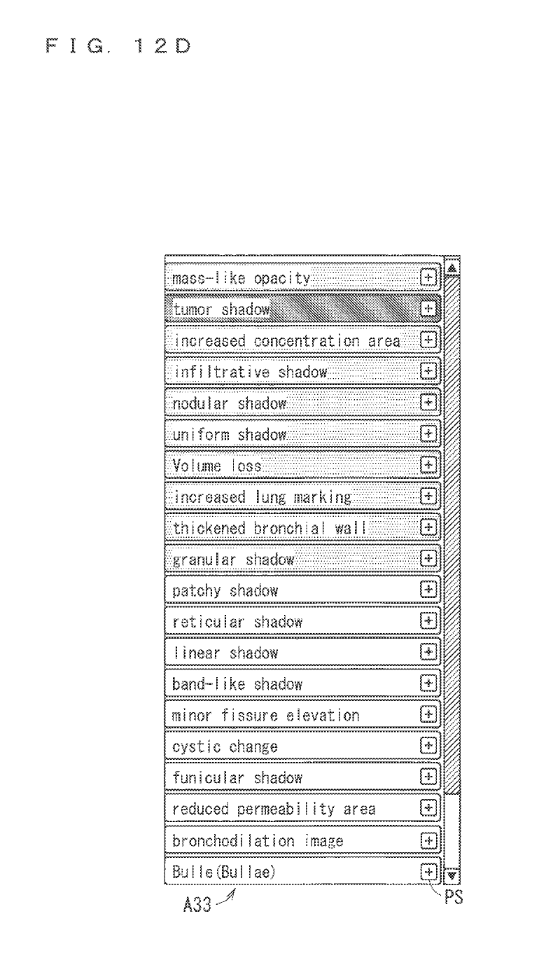

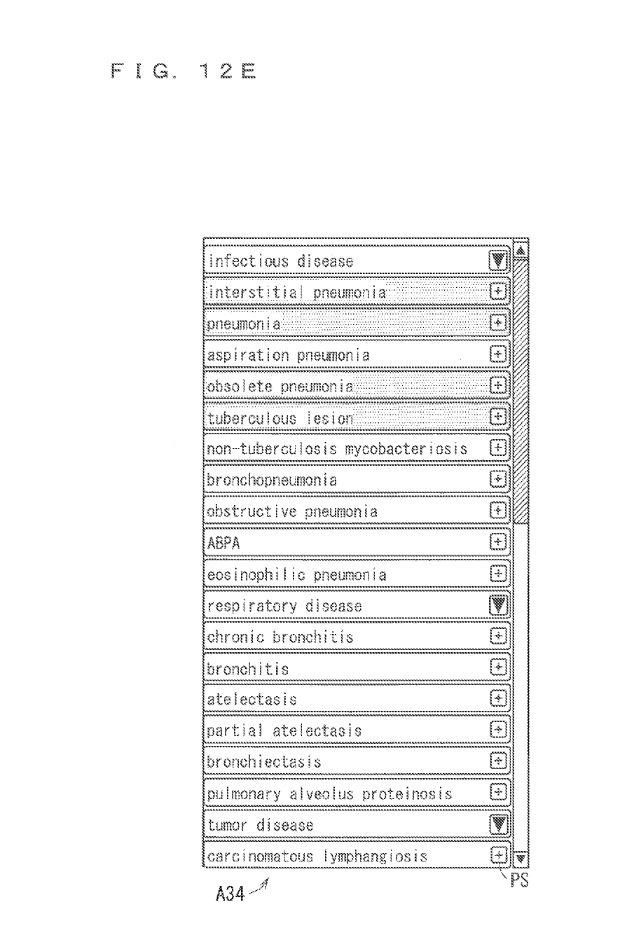

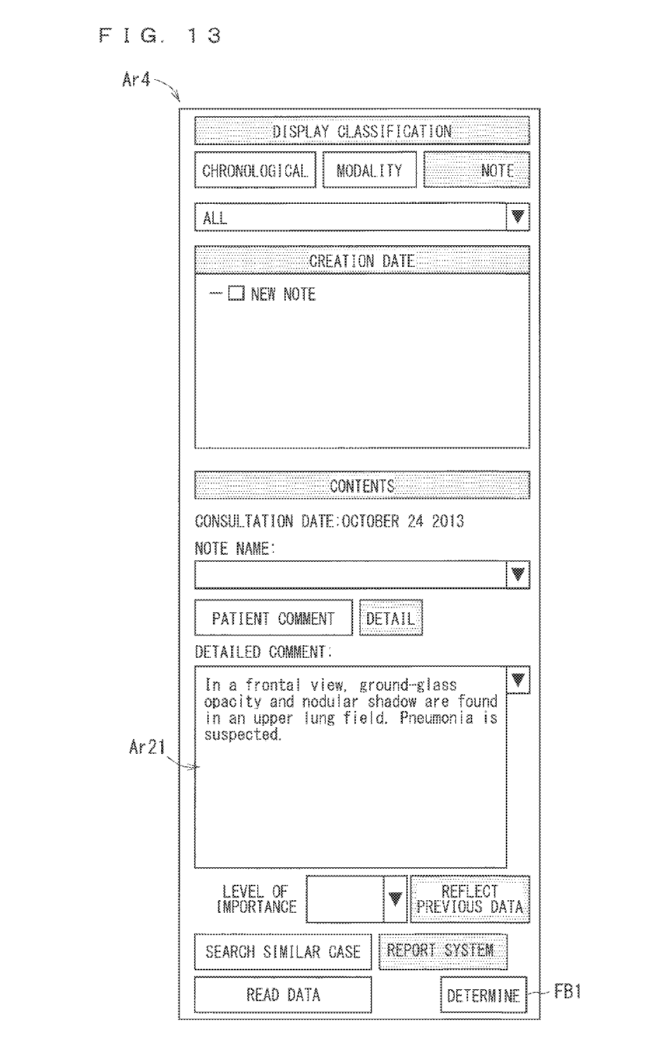

The support information extraction unit 316 extracts a variety of information from the support information DB 122 in accordance with the condition selected by the condition selection unit 315. The variety of information extracted herein includes the term table TL1 and the combination number table TL2 that correspond to the combination of terms concerning the examined body part, the modality, and the category as selected by the condition selection unit 315, for example. The variety of information extracted by the support information extraction unit 316 is visually output from the display unit 340a as appropriate by the display controller 314a included in the output controller 314. As a result, an input support template (FIG. 12) is displayed in a third area Ar3 of a diagnosis support screen SD1 (FIG. 11), which is described later, for example.

The term designation unit 317 designates a term for each item in the input support template (FIG. 12) in response to a signal from the operation unit 330.

The sentence generation unit 318 generates a finding sentence that complies with a preset sentence model in accordance with the term designated by the term designation unit 317 for each item. That is to say, the sentence generation unit 318 generates the finding sentence based on the term designated by the term designation unit 317, which is a designation unit, for each item. The finding sentence generated herein is displayed in the input support template (FIG. 12) through control performed by the display controller 314a.

The writing unit 319 writes data on the finding sentence generated by the sentence generation unit 318 as information on a corresponding creation target examination included in the medical care information DB 121 in response to a signal from the operation unit 330.

FIG. 10 shows an example of a screen (the examination list screen) DL1 that is used in the terminal devices 31 (32 and 33) to designate a creation target examination as a target for creation of a diagnostic result report when the diagnostic result report is created.

The examination list screen DL1 is displayed by the display unit 340a through control performed by the display controller 314a included in the output controller 314 by performing a predetermined operation in the terminal device 31 (32 and 33) after start-up of the program PG2. For example, in accordance with an operation performed on the operation unit 330 by a doctor as a user of the terminal device 31, information on the examination list stored in the medical care information DB 121 is input into the terminal device 31 via the reading unit 311. By then visually outputting the information on the examination list from the display unit 340a under control performed by the display controller 314a, display of the examination list screen DL1 is achieved.

As shown in FIG. 10, the examination list screen DL1 displays information pieces on an examination (specifically, a patient ID, a patient name, a birth date, age, sex, a state, an examination ID, an examination date, an examined body part, a modality, the number of images, and the like) as a list. In this examination list screen DL1, an examination that is indicated by a state “not created” corresponds to an examination for which a diagnostic result report has not been created.

In the examination list screen DL1, a cursor CS1 represented by a solid frame is moved up and down in accordance with the operation performed on the operation unit 330 by the doctor. When a set button (e.g., a return key) on the operation unit 330 is pressed in a state in which the solid frame cursor CS1 is set to a desired examination, one examination indicated by the solid frame cursor CS1 is designated by the examination designation unit 312 as a creation target examination.

When the creation target examination is designated as described above, a screen displayed by the display unit 340a transitions from the examination list screen DL1 to a screen (also referred to as a diagnosis support screen) SD1 for supporting input of a diagnostic result report for the creation target examination. In this case, in accordance with the designation of the creation target examination by the examination designation unit 312, the management unit 313 specifies a task of creating a diagnostic result report corresponding to the creation target examination, and causes the reading unit 311 to read a variety of information and data on the creation target examination from the medical care information DB 121.

FIG. 11 shows an example of the diagnosis support screen SD1. The diagnosis support screen SD1 is mainly composed of first to fourth areas Ar1-Ar4.

In the first area Ar1, various buttons used for switching of a display screen are displayed. In the second area Ar2, image data on the creation target examination is visually output. In the third area Ar3, a template for supporting input of a diagnostic result report (also referred to as the input support template) is displayed. In the fourth area Ar4, contents of a record regarding the creation target examination are displayed.

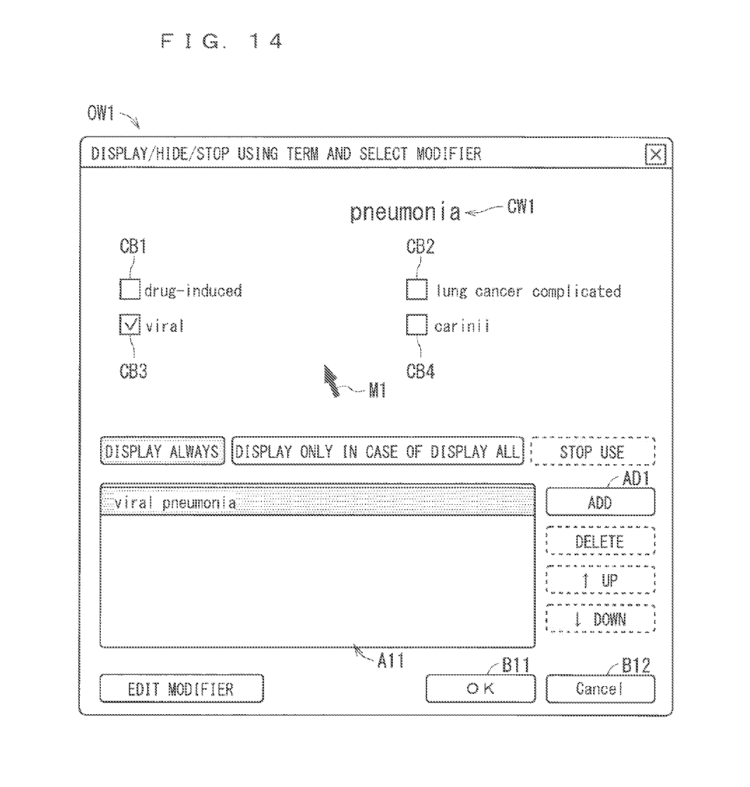

FIGS. 12A to 12E show a display example of the input support template displayed in the third area Ar3 of the diagnosis support screen SD1. FIG. 13 shows a display example in the fourth area Ar4.

The input support template is prepared for each combination of an examined body part and a modality in the creation target examination. FIGS. 12A to 12E show an input support template prepared for a combination of an examined body part “CHEST” and a modality “CR” as an example. Input and designation of a variety of information in the input support template are performed under control performed by the term designation unit 317 based on a signal input in response to an operation performed on the operation unit 330 by a doctor.

As shown in FIG. 12A, a presentation information create button SB1 is displayed in an upper part of the input support template, and, below the presentation information create button SB1, display elements PM1-PM4 that indicate respective combinations of an examined body part and a modality in the creation target examination are displayed. FIGS. 12A to 12E show an example in which a combination of an examined body part and a modality in the creation target examination is a combination of an examined body part “CHEST” and a modality “CR”. Below the display elements PM1-PM4, a reset button RB1, category designate buttons SP1-SP5, and an input button IB1 are displayed. In a middle part, selection areas A31-A34 are displayed. In a lower part, text boxes Tb1-Tb4, preposition lists PL1 and PL2 and predicate lists PL3 and PL4 are displayed. In the input support template, pressing of various buttons and appearance of a cursor are achieved by a mouse pointer M1 that works in accordance with an operation performed on the operation unit 330, for example.

The presentation information create button SB1 is a button for transitioning from a mode in which a diagnostic result report is created (also referred to as a report creation mode) to a mode in which presentation information is created (also referred to as a presentation information creation mode). FIGS. 11 and 12A to 12E show a state in which a mode is set to the report creation mode. The input support template is in the report creation mode in its initial state.

The category designate buttons SP1-SP5 are buttons for selectively designating a term concerning a category for the diagnostic result report as an input target. For example, one or more terms concerning a category corresponding to a combination of an examined body part and a modality in the creation target examination are identified from the term table TL1, so that buttons for selectively designating the one or more terms are shown. In the input support template shown in FIGS. 12A to 12E, by selectively pressing any one of the five category designate buttons SP1-SP5 with the mouse pointer Ml, the term concerning the category for the diagnostic result report as the input target is selectively designated.

In the input support template shown in FIG. 12, one of five terms “lung”, “mediastinum”, “bone”, “soft part”, and “pleura (margin)” concerning the category is designated. When a term concerning a desired category is designed, the condition selection unit 315 selects a combination of terms concerning an examined body part and a modality in the creation target examination and the term concerning the category designated by one of the category designate buttons SP1-SP5. The support information extraction unit 316 extracts, from the term table TL1 included in the support information, data on terms belonging to respective items classified as the designated combination of terms. Based on the extracted data on terms belonging to the respective items, the display unit 340a achieves visual output in the selection areas A31-A34 under control performed by the display controller 314a.

The selection areas A31-A34 are large areas that occupy the middle part of the input support template, and are sequentially arranged from left to right in the stated order. Specifically, as shown in FIG. 12B, in the selection area A31, a plurality of options for a term that belongs to the item “shooting condition” (e.g., a frontal view, a lateral view, and a lateral decubitus view) are listed downwards. As shown in FIG. 12C, in the selection area A32, a plurality of options for a term that belongs to the item “basic body part” (e.g., an entire lung field, an upper lung field, and a middle lung field) are listed downwards. As shown in FIG. 12D, in the selection area A33, a plurality of options for a term that belongs to the item “basic findings” (e.g., tumor shadow, ground-glass opacity, and an increased concentration area) are listed downwards. As shown in FIG. 12E, in the selection area A34, a plurality of classes that belong to the item “diagnosis” (e.g., an infectious disease, a respiratory disease, and a tumor disease) are listed downwards, and, for each of the classes, a plurality of options for a term (e.g., interstitial pneumonia, pneumonia, and aspiration pneumonia) are listed downwards. That is to say, in the selection areas A31-A34, a plurality of options for the terms that belong to the items “shooting condition”, “basic body part”, “basic findings”, and “diagnosis” are presented so as to be distinguishable by an item.

In the selection area A31, when a desired option for the term is pressed with the mouse pointer M1 in accordance with an operation performed on the operation unit 330 by a doctor, the desired option for the term is designated for the item “shooting condition”. In this case, the designated option for the term is shown so as to be distinguishable from the other options (e.g., highlighted), and the designated term is displayed in the text box Tb1 as a term that belongs to the item “shooting condition”.

In the selection area A32, when a desired option for the term is pressed with the mouse pointer M1 in accordance with an operation performed on the operation unit 330 by a doctor, the desired option for the term is designated for the item “basic body part”. In this case, the designated option for the term is shown so as to be distinguishable from the other options (e.g., highlighted), and the designated term is displayed in the text box Tb2 as a term that belongs to the item “basic body part”. Furthermore, by pressing any of buttons “L”, “B”, “R” provided on the left side of the designated option for the term, a modifier “left”, “both”, or “right” can be added to the term displayed in the text box Tb2 as appropriate.

In the selection area A33, when a desired option for the term is pressed with the mouse pointer M1 in accordance with an operation performed on the operation unit 330 by a doctor, the desired option for the term is designated for the item “basic findings”. In this case, the designated option for the term is shown so as to be distinguishable from the other options (e.g., highlighted), and the designated term is displayed in the text box Tb3 as a term that belongs to the item “basic findings”.

In the selection area A34, when a desired option for the term is pressed with the mouse pointer M1 in accordance with an operation performed on the operation unit 330 by a doctor, the desired option for the term is designated for the item “diagnosis”. In this case, the designated option for the term is shown so as to be distinguishable from the other options (e.g., highlighted), and the designated term is displayed in the text box Tb4 as a term that belongs to the item “diagnosis”.

In the selection areas A31-A34, a detail designate button PS is provided on the right side of each option for the term. When the detail designate button PS is pressed with the mouse pointer M1, a window (also referred to as a detail input window) OW1 in which a detailed element that modifies the designated term can be input is displayed so as to be overlaid on the input support template. The detailed element includes a term such as a modifier, for example.

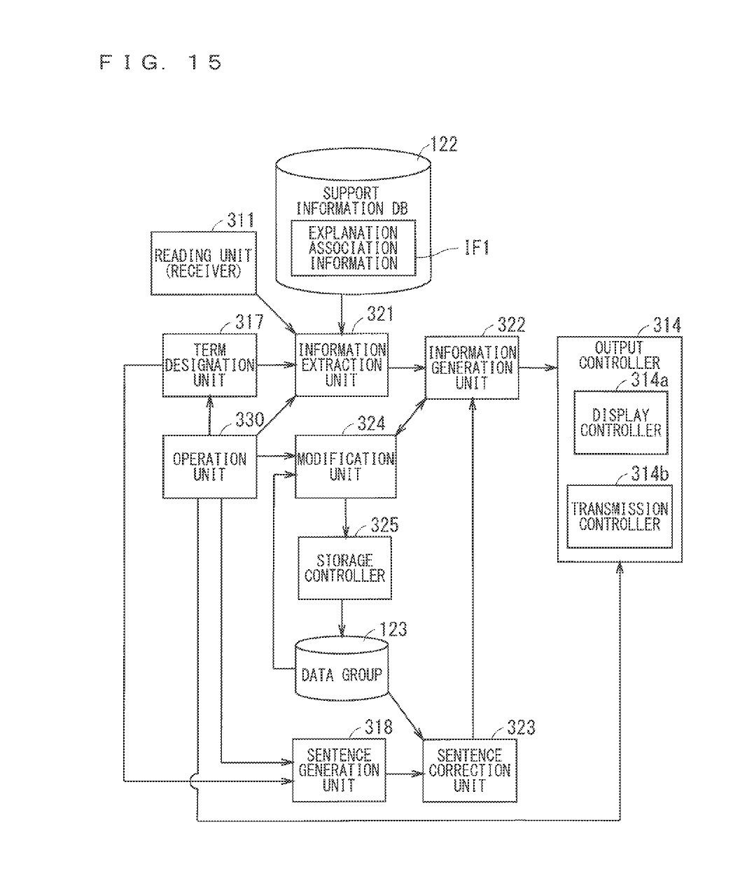

FIG. 14 shows an example of the detail input window OW1. In the detail input window OW1, a term (also referred to as an addition target term) CW1 (e.g., pneumonia) to which a detailed element is to be added is shown in an upper part, and candidates for the detailed element to be added (drug-induced, lung cancer complicated, viral, and carinii) are listed under the addition target term. When any of check boxes CB1-CB4 provided on the left sides of the respective candidates for the detailed element is checked with the mouse pointer M1, and an add button AD1 is pressed, a term obtained by adding the checked detailed element to the addition target term CW1 is displayed in an area A11. An OK button B11 and a cancel button B12 are provided in a lower part of the detail input window OW1. When the cancel button B12 is pressed with the mouse pointer M1, display of the detail input window OW1 is simply terminated. When the OK button B11 is pressed with the mouse pointer M1, the term displayed in the area A11 is employed, and display of the detail input window OW1 is terminated. For example, when a term “viral pneumonia” that belongs to the item “diagnosis” is displayed in the area A11, the term “viral pneumonia” is displayed in the text box Tb4 as a term that belongs to the item “diagnosis” in response to pressing of the OK button B11.

A desired term may directly be input into each of the text boxes Tb1-Tb4 by causing a cursor to appear in each of the text boxes Tb1-Tb4, and inputting the term with a keyboard and the like.

The preposition list PL1 is a list for selectively designating a preposition for the item “shooting condition”. The preposition list PL2 is a list for selectively designating a preposition for the item “basic body part”. The predicate list PL3 is a list for selectively designating a predicate for the item “basic findings”. The predicate list PL4 is a list for selectively designating a predicate for the item “diagnosis”. The preposition lists PL1 and PL2 and the predicate lists PL3 and PL4 are each a so-called pull down list which is pulled down with the mouse pointer M1 and from which a single preposition or predicate can selectively be designated.

The reset button RB1 is a button for inputting an instruction to reset an input state of the input support template. When the reset button RB1 is pressed with the mouse pointer M1, terms input into the text boxes Tb1-Tb4 are deleted, and at least one of prepositions and predicates designated in the predicate lists PL1-PL4 are reset to a default state.

The input button IB1 is a button for issuing an instruction to input a finding sentence. When the input button IB1 is pressed with the mouse pointer M1 in a state in which terms that belong to the respective four items “shooting condition”, “basic body part”, “basic findings” and “diagnosis” are input into the four text boxes Tb1-Tb4, a finding sentence is generated based on the terms input into the four text boxes Tb1-Tb4, the prepositions designated in the preposition lists PL1 and PL2 and the predicates designated in the predicate lists PL3 and PL4. The finding sentence is herein generated by the sentence generation unit 318. The finding sentence generated herein is automatically input into a comment display area Ar21 (FIG. 13) in the fourth area Ar4 of the diagnosis support screen SD1. The finding sentence input into the comment display area Ar21 is a finding sentence intended for a doctor, who has specialized medical knowledge.

In the selection areas A31-A34, when an option for the term is designated for each of one or more items, one or more options that are more relevant to the designated term or the designated combination of terms than the other options are selected from among options for terms that belong to the other items, and are shown, as stronger candidates, so as to be distinguishable from the other options. This facilitates designation of an option. Relevance can be determined by judging whether the number of times each option for the term is combined with the designated term or the designated combination of terms meets a predetermined criterion with reference to the combination number table TL2. An example of the predetermined criterion is a preset criterion value regarding the absolute value of the number of combinations and a ratio of the number of combinations to the total number of combinations. For example, when three terms “frontal view”, “entire lung field”, and “ground-glass opacity” are designated as terms that belong to respective three items (a shooting condition, a basic body part, and basic findings), options “interstitial pneumonia”, “pneumonia”, “aspiration pneumonia”, and the like that are more relevant to a combination of these three terms are shown, as options for the term that belongs to the remaining item “diagnosis”, so as to be distinguishable from the other options. The options may be shown so as to be distinguishable, for example, by using a different contrast or a different concentration.

A doctor, who is the first user, can easily create a finding sentence by designating an option for a term in each of the selection areas A31-A34 with reference to image data on the creation target examination visually output in the second area Ar2 of the diagnosis support screen SD1. For example, when terms “frontal view”, “entire lung field”, “ground-glass opacity”, and “pneumonia” are designated as terms that belong to respective four items (a shooting condition, a basic body part, basic findings, and diagnosis), finding sentences “In a frontal view, ground-glass opacity is found in the entire lung field. Pneumonia is suspected.” can be created, for example. For a specific item (e.g., basic findings), two or more options for the term may be designated to crease a finding sentence. Specifically, when terms “frontal view”, “entire lung field”, “ground-glass opacity”, “nodular shadow”, and “pneumonia” are designated as terms that belong to four items (a shooting condition, a basic body part, basic findings, and diagnosis), finding sentences “In a frontal view, ground-glass opacity and nodular shadow are found in the entire lung field. Pneumonia is suspected.” can be created, for example.

When a determine button FB1 provided below the comment display area Ar21 is pressed with the mouse pointer M1 in a state in which a finding sentence is displayed in the comment display area Ar21, contents of the diagnostic result report are determined. The writing unit 319 then registers report data on the new diagnostic result report with the medical care information DB 121. When a complete button is pressed with the mouse pointer M1 in the diagnosis support screen SD1, a screen displayed by the display unit 340a transitions from the diagnosis support screen SD1 (FIG. 11) to the examination list screen DL1 (FIG. 10).

### <(3-3) Explanation Presentation Processing>

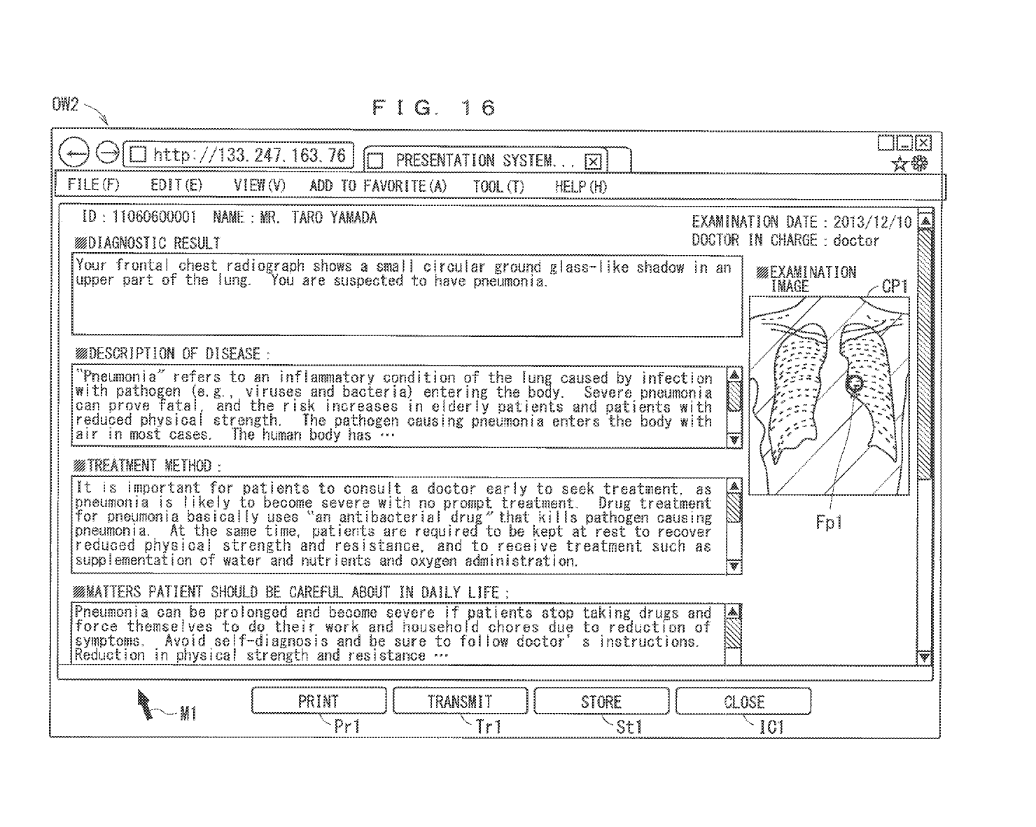

FIG. 15 is a block diagram showing examples of functional components for implementing the explanation presentation processing in the information processing system 1.

The information processing system 1 includes, as functional components for implementing the explanation presentation processing achieved by the controllers 110 and 310, the reading unit 311, the output controller 314, the term designation unit 317, the sentence generation unit 318, an information extraction unit 321, an information generation unit 322, a sentence extraction unit 323, a modification unit 324, and a storage controller 325.

As described above, the reading unit 311 reads a variety of data on the creation target examination from the medical care information DB 121. At the same time, the reading unit 311 reads an element that belongs to the item concerning the patient attribute. That is to say, the reading unit 311, as a receiver, receives input of the element that belongs to the item concerning the patient attribute.

As described above, the term designation unit 317 designates a term for each item in the input support template (FIG. 12) in response to a signal from the operation unit 330. That is to say, the term designation unit 317, as a designation unit, designates a combination of terms that belong to two or more of a plurality of items in response to a signal according to a user action. In the present embodiment, the plurality of items include “patient attribute”, “basic body part”, “basic findings”, and “diagnosis”, and the two or more items include “basic body part”, “basic findings”, and “diagnosis”.

The information extraction unit 321 extracts, from the explanation association information IF1 (e.g., FIG. 7) included in the support information DB 122, an explanation information piece that corresponds to the combination of terms designated by the term designation unit 317. That is to say, the information extraction unit 321, as an extraction unit, extracts, from a plurality of explanation information pieces stored in the storage 120, the explanation information piece that corresponds to the combination of terms designated by the term designation unit 317, as the designation unit. In the present embodiment, from the plurality of explanation information pieces stored in the storage 120, an explanation information piece that corresponds to a combination of the combination of terms designated by the term designation unit 317, as the designation unit, and one or more terms concerning the patient attribute whose input is received by the reading unit 311, as the receiver, is extracted. For example, an explanation information piece that corresponds to a combination of three terms (an upper lung field, nodular shadow, and pneumonia) designated as the terms that belong to three items (a basic body part, basic findings, and diagnosis) and a term that belongs to the item concerning the patient attribute (male (M)) is extracted. For example, no term concerning the patient attribute may be included the combination of a plurality of terms in the explanation association information IF1, and an explanation information piece that corresponds to the combination of terms designated by the term designation unit 317, as the designation unit, may be extracted.

The information generation unit 322 generates an output information piece by using the explanation information piece extracted by the information extraction unit 321. The information piece generated herein is output to the output controller 314.

The output controller 314 causes the output unit 340 to output the explanation information piece extracted by the information extraction unit 321, as the extraction unit. Specifically, the output controller 314 causes the display unit 340a to visually output the information generated by the information generation unit 322 by using the display controller 314a included in the output controller 314, for example. A transmission controller 314b included in the output controller 314 causes the I/F unit 340b included in the output unit 340 to transmit the information generated by the information generation unit 322 to a transmission target device. The transmission target device herein includes the terminal devices 61-63 and the DC server 70. The information is transmitted to the terminal devices 61-63 as text of an email or an attachment to an email, for example. The information is transmitted to the DC server 70 so that the data is stored in the PHR 71, for example. Storing the data in the PHR 71 may be achieved by, after the data is once stored in the main server 10, the DC server 70 reading the data.

As described above, the sentence generation unit 318 generates a finding sentence based on the term designated for each item by the term designation unit 317, as the designation unit.

The sentence correction unit 323 corrects the finding sentence generated by the sentence generation unit 318, as a generation unit, by performing first correction processing and second correction processing, thereby generating a corrected finding sentence for explanation (also referred to as a sentence showing a diagnostic result). The first correction processing is herein processing of replacing one or more terms included in the finding sentence generated by the sentence generation unit 318 with other terms based on a first rule. The other terms are terms that can easily be understood by a person with no specialized medical knowledge, for example. The second correction processing is herein processing of changing one or more expressions included in the finding sentence generated by the sentence generation unit 318 to other expressions based on a second rule. The one or more expressions are changed to the other expressions by complementing the one or more expressions with words and phrases such as a subject, a modifier, a preposition, and an auxiliary verb. The sentence generation unit 318 and the sentence correction unit 323 thus generate a finding sentence intended for a person with specialized medical knowledge (e.g., a doctor and a nurse) and a sentence showing a diagnostic result intended for a person with no specialized medical knowledge (e.g., a patient and a person who is relevant to the patient). As a result, an appropriate explanation that suits a level of a subject can be presented.

The first and second rules are herein preferably set in advance. The first rule can be defined by a table in which a term and a candidate for a replacing term are associated with each other, for example. The second rule can be defined by information (e.g., a model pattern that shows the structure of sentences) that shows a method for complementing a sentence model of the finding sentence with words and phrases. The finding sentence corrected by the sentence correction unit 323 is output by the output unit 340 in accordance with control performed by the output controller 314.

The modification unit 324 modifies the explanation information piece extracted by the information extraction unit 321 in response to a signal according to a user action. Modification herein includes various types of change, including addition to the explanation information piece and correction, underlining, and marking of the explanation information piece, for example. The explanation information piece modified by the modification unit 324 is output by the output unit 340 in accordance with control performed by the output controller 314. As a result, a more appropriate explanation according to a current state of each patient can be presented.

The storage controller 325 causes the storage 120 to store the explanation information piece modified by the modification unit 324. The modified explanation information piece may be stored so as to be included in the data group 123, and may be reused for subsequent modification of an explanation information piece made by the modification unit 324, for example. Specifically, in a case where a doctor wants to make a similar modification to the same explanation information piece, the explanation information piece modified in the past may be read from the data group 123, and reused in accordance with a predetermine operation, for example. According to this structure, an appropriate explanation customized by a doctor as an individual user can efficiently be used. When the modified explanation information piece is stored in the storage 120 so as to be sortable, searchable, and extractable in accordance with information on a term in each item and the patient attribute, the modified explanation information piece can easily be reused.

FIG. 16 shows an example of an explanation presentation window OW2 in which the explanation information piece is visually output. In the present embodiment, when the presentation information create button SB1 is pressed with the mouse pointer M1 in a state in which contents of the diagnostic result report including a finding sentence are determined in the above-mentioned diagnosis support screen SD1, a mode transitions from the report creation mode to the presentation information creation mode. In this case, the information extraction unit 321 extracts an explanation information piece that corresponds to a combination of terms designated by the term designation unit 317 from the explanation association information IF1 included in the support information DB 122. The information generation unit 322 then generates output information by using the extracted explanation information piece. The display controller 314a included in the output controller 314 causes the display unit 340a to visually output the output information, so that the explanation presentation window OW2 is displayed so as to be overlaid on the second area Ar2 and the third area Ar3 of the diagnosis support screen SD1.

FIG. 16 shows an example of the explanation presentation window OW2 in a case where the term “frontal view” is designated as a term that belongs to the item “shooting condition”, the term “upper lung field” is designated as a term that belongs to the item “basic body part”, the terms “ground-glass opacity” and “nodular shadow” are designated as terms that belong to the item “basic findings”, and the term “pneumonia” is designated as a term that belongs to the item “diagnosis”. In the explanation presentation window OW2, explanation information pieces on four items (a diagnostic result, description of a disease, a treatment method, and matters a patient should be careful about in daily life) are presented, for example. Each of these explanation information pieces is composed of sentences that can easily be understood by a person with no specialized medical knowledge, and includes information on a causal relationship between a cause and a medical condition and a means of coping with a disease, for example. In the explanation presentation window OW2, an examination image CP1 is shown, and a problematic part Fp1 of the examination image CP1 is clearly shown by a frame, an arrow, and the like, for example. The explanation information piece on the item “diagnostic result” may be the sentence extracted from the explanation association information IF1 included in the support information DB 122, and may be the explanation finding sentence corrected by the sentence correction unit 323, for example.

In a lower part of the explanation presentation window OW2, a print button Pr1, a transmit button Tr1, a store button St1, and a presentation information close button IC1 are provided.

When the print button Pr1 is pressed with the mouse pointer M1, contents presented in the explanation presentation window OW2 may be printed out by a printer that is connected directly to the terminal device 31 or connected indirectly to the terminal device 31 via the communication line W1. With this structure, a doctor can present an appropriate explanation according to a current state of each patient, for example, by handing the printout to the patient or a person who is relevant to the patient during examination of the patient.

When the transmit button Tr1 is pressed with the mouse pointer M1, the transmission controller 314b may cause the contents presented in the explanation presentation window OW2 to be transmitted in the form of an email and the like to the terminal device 61 (62 and 63), as the transmission target device, owned by a patient or a person who is relevant to the patient, for example.

When the store button St1 is pressed with the mouse pointer M1, the contents presented in the explanation presentation window OW2 may be transmitted to the DC server 70, as the transmission target device, and stored in the PHR 71 and the like, for example. In this case, a patient and a person who is relevant to the patient can view the contents presented in the explanation presentation window OW2 by accessing the PHR 71 included in the DC server 70 by using the terminal devices 61-63. According to this structure, an appropriate explanation according to a current state of each patient can also easily be presented to a subject. When the store button St1 is pressed with the mouse pointer M1, the contents presented in the explanation presentation window OW2 may be stored in a portable recording medium, and the portable recording medium may be handed to a patient. Alternatively, when the store button St1 is pressed, the storage controller 325 may store the contents presented in the explanation presentation window OW2 in association with information on a patient (e.g., a diagnostic result report and an electronic medical record) included in the medical care information DB 121.

In the explanation presentation window OW2, a doctor can edit sentences and add a modifier, such as underlining and marking, to sentences by appropriately operating the operation unit 330. Such operation is achieved by the modification unit 324. By modifying an explanation information piece as described above, an appropriate explanation according to each patient can be presented. As a result, a more appropriate explanation according to a current state of each patient can be presented to a subject by the information displayed in the explanation presentation window OW2.

When the presentation information close button IC1 is pressed with the mouse pointer M1, the explanation presentation window OW2 is closed, and a mode transitions to the report creation mode.

### <(4) Summary>

As set forth above, in the information processing system 1 according to the above-mentioned one embodiment, explanation information pieces are stored in association with respective combinations of elements that belong to two or more items concerning a current state of a patient, and, in accordance with doctor's designation of a combination of elements, an explanation information piece that corresponds to the designated combination is extracted and output. As a result, an appropriate explanation according to a current state of each patient can be presented to a subject. Since the corresponding explanation information piece is extracted and output in accordance with doctor's designation of a combination of elements in the report creation processing, for example, an appropriate explanation according to a current state of each patient can easily be presented to a subject. The two or more items concerning a current state of a patient includes items concerning a body part, findings, and diagnosis, and thus an appropriate explanation according to a result of examination, such as image diagnosis, can be presented to a subject.

### <(5) Modifications>

It should be noted that the present invention is not limited to the above-mentioned one embodiment, and various modifications and improvements can be made without departing from the scope of the present invention.

For example, in the above-mentioned one embodiment, an explanation information piece is output by visually outputting text information. The present invention, however, is not limited to this structure. For example, an explanation information piece may be output in the form of a sound and other forms. With this structure, even when a subject, including a patient and a person who is relevant to the patient, has reduced vision as typified by elderly people, an appropriate explanation according to a current state of each patient can be presented to the subject. When an explanation information piece is output in the form of a sound, modification of the explanation information piece made by the modification unit 324 includes change of an accent and an intonation when the explanation information piece is output as a sound.

In the above-mentioned one embodiment, options for terms that belong to four items are listed concurrently in the input support template as shown in FIGS. 12A to 12E, and an option for a term is designated for each item. The present invention, however, is not limited to this structure. For example, the options for the terms may sequentially be presented in the input support template, for example, in the order of the items “shooting condition”, “basic body pert”, “basic findings”, and “diagnosis” so that an option for a term can be designated for each item.

In the above-mentioned one embodiment, an example in which a doctor creates a diagnostic result report is shown. The present invention, however, is not limited to this structure. For example, explanation information pieces may be stored in association with respective combinations of terms that belong to two or more items concerning a current state of a patient, and, in response to user's designation of a combination of terms, an explanation information piece that corresponds to the designated combination may be extracted and output. Specifically, items and terms may be changed to those intended for general users, and, by the general users selecting a term that belongs to each item, self-diagnosis may be performed, and an explanation information piece may be extracted and output as a result of the self-diagnosis.

In the above-mentioned one embodiment, various functions for achieving the medical care support processing and the like performed in the in-hospital system 2 are shared by the main server 10 and the terminal devices 31-33. A ratio of functions achieved by the main server 10 to functions achieved by the terminal devices 31-33, however, may be changed as appropriate.

In the above-mentioned one embodiment, the in-hospital system 2 is a server-client system in which the main server 10 and the terminal devices 31-33 are connected via the communication line W1. The present invention, however, is not limited to this structure. For example, functions of the above-mentioned in-hospital system 2 may be achieved by a single computer, assuming that the in-hospital system 2 is a system in a private hospital.

In the above-mentioned one embodiment, a plurality of terms that are associated with respective explanation information pieces belong to two or more items concerning a current state of a patient that includes the patient attribute. The present invention, however, is not limited to this structure. For example, the plurality of terms that are associated with the respective explanation information pieces may not include a term concerning the patient attribute. Alternatively, the plurality of terms that are associated with the respective explanation information pieces may include a term indicating a state of a patient. Examples of the term indicating the state of the patient are a numerical value and a value range of body temperature and blood pressure. That is to say, a plurality of items concerning a current state of a patient and two or more of the plurality of items may include an item concerning at least one of an attribute and a state of a patient. In this case, the information extraction unit 321 extracts, from a plurality of explanation information pieces stored in the storage 120, an explanation information piece that corresponds to a combination of terms designated by the term designation unit 317 and one or more terms concerning at least one of an attribute and a state of a patient whose input is received by the reading unit 311.

The plurality of terms that are associated with the respective explanation information pieces may not include a term concerning an attribute and a state of a patient. When the plurality of terms that are associated with the respective explanation information pieces include the term concerning at least one of the attribute and the state of the patient, however, an appropriate explanation according to a more detailed current state of each patient can be presented to a subject. For example, the effects of quitting smoking vary depending on age group. In this case, when the plurality of terms that are associated with the respective explanation information pieces include a term concerning an age group as the patient attribute, an appropriate explanation according to a more detailed current state of each patient can be presented to a subject.

In the above-mentioned one embodiment, the sentence generation unit 318 generates a finding sentence based on terms that are designated by the term designation unit 317, as the designation unit, for respective four items. The present invention, however, is not limited to this structure. For example, the sentence generation unit 318 may generate a finding sentence based on two or more terms that are designated by the term designation unit 317, as the designation unit, for respective two or more of the plurality of items.

In the above-mentioned one embodiment, an element that belongs to each item is a term. The present invention, however, is not limited to this structure. The element that belongs to each item may be other elements, such as various words and phrases and a diagram that indicates a position and an area.

In the above-mentioned one embodiment, an instruction signal is input in accordance with an operation performed by a user on the operation unit 330. The present invention, however, is not limited to this structure. For example, in response to input of a sound, the sound may be analyzed, and an instruction signal may be input. That is to say, the instruction signal is preferably input in accordance with an operation performed by a user.

It should be appreciated that all or part of the one embodiment and various modifications set forth above can appropriately be combined with one another unless any contradiction occurs.

While the invention has been shown and described in detail, the foregoing description is in all aspects illustrative and not restrictive. It is therefore understood that numerous modifications and variations can be devised without departing from the scope of the invention.

What is claimed is:

1. An information processing system comprising:
a storage that stores therein explanation information pieces and a plurality of element combinations in each of which a plurality of elements that belong to two or more of a plurality of items concerning a current state of a patient are associated with one another, each of said explanation information pieces being to be presented to one or more of a patient who is associated with a corresponding one of said element combinations and a person who is relevant to the patient;
a designation unit that designates, in response to a signal according to a user action, a combination of elements belonging to two or more of said plurality of items;
an extraction unit that extracts, from said explanation information pieces stored in said storage, an explanation information piece that corresponds to said combination of elements designated by said designation unit; and
an output controller that causes an output unit to output said explanation information piece extracted by said extraction unit.

2. The information processing system according to claim 1 further comprising
a modification unit that modifies, in response to a signal according to a user action, said explanation information piece extracted by said extraction unit, wherein
said output controller causes said output unit to output said explanation information piece modified by said modification unit.

3. The information processing system according to claim 2 further comprising
a storage controller that causes said storage to store therein said explanation information piece modified by said modification unit.

4. The information processing system according to claim 1 further comprising:
a generation unit that generates a sentence based on the elements belonging to two or more of said plurality of items as designated by said designation unit; and
a correction unit that corrects said sentence generated by said generation unit by performing at least one of first correction processing of replacing one or more terms with other terms based on a preset first rule and second correction processing of changing one or more expressions to other expressions based on a preset second rule, wherein
said output unit outputs said sentence corrected by said correction unit.

5. The information processing system according to claim 1 further comprising
a receiver that receives input of an element that belongs to an item concerning at least one of an attribute and a state of a patient, wherein
said plurality of items include the item concerning at least one of the attribute and the state of the patient, and
said extraction unit extracts, from said explanation information pieces stored in said storage, an explanation information piece that corresponds to a combination of said combination of elements designated by said designation unit and one or more elements whose input is received by said receiver.

6. The information processing system according to claim 1, wherein
said plurality of items include items concerning a body part, findings, and diagnosis.

7. The information processing system according to claim 1, wherein
said output controller includes a transmission controller that causes said output unit to transmit said explanation information piece to a transmission target device.

8. A non-transitory computer readable recording medium storing a computer-readable program, the program controlling an information processing system to operate as one information processing system, and the one information processing system comprising:
a storage that stores therein explanation information pieces and a plurality of element combinations in each of which a plurality of elements that belong to two or more of a plurality of items concerning a current state of a patient are associated with one another, each of said explanation information pieces being to be presented to one or more of a patient who is associated with a corresponding one of said element combinations and a person who is relevant to the patient;
a designation unit that designates, in response to a signal according to a user action, a combination of elements belonging to two or more of said plurality of items;
an extraction unit that extracts, from said explanation information pieces stored in said storage, an explanation information piece that corresponds to said combination of elements designated by said designation unit; and
an output controller that causes an output unit to output said explanation information piece extracted by said extraction unit.
